(19) United States
(12) Patent Application Publication
(10) Pub. No.: US 2022/0417523 A1
(43) Pub. Date: Dec. 29, 2022

(54) ENCODING METHOD, ENCODING APPARATUS AND PROGRAM

(71) Applicant: NIPPON TELEGRAPH AND TELEPHONE CORPORATION, Tokyo (JP)

(72) Inventors: Seishi TAKAMURA, Musashino-shi, Tokyo (JP); Hideaki KIMATA, Musashino-shi, Tokyo (JP)

(73) Assignee: NIPPON TELEGRAPH AND TELEPHONE CORPORATION, Tokyo (JP)

(21) Appl. No.: 17/775,759

(22) PCT Filed: Nov. 18, 2019
(86) PCT No.: PCT/JP2019/045083

§ 371 Date: May 10, 2022

(51) Int. Cl. H04N 19/139; H04N 19/119; H04N 19/105; H04N 19/52

(52) U.S. Cl. CPC H04N 19/139; H04N 19/119; H04N 19/105; H04N 19/52

(57) ABSTRACT

A coding method for coding an image to be coded using a reference image includes identifying a reference area being a part of the reference image, the reference area corresponding to an area to be coded being an area obtained by dividing the image to be coded, and obtaining a predicted area with respect to the area to be coded, by prediction using the reference area. The area to be coded and the reference area have different sizes and/or different shapes. In the identifying, the reference area is identified by utilizing a difference between a manner of projection of an object corresponding to the area to be coded and a manner of projection of the object corresponding to the reference area, due to an operation performed on a camera when the image to be coded and the reference image are acquired.

### TECHNICAL FIELD

The present invention relates to a coding method, a coding apparatus, and a program.

### BACKGROUND ART

A camera may capture a video of a physical body having a flat outer appearance, such as a painting, a tablet, or a ground (hereinafter, referred to as a “flat physical body”). A shape, a size, and a position of an image of the physical body captured in each frame of a moving image are different according to a movement of the physical body and a movement of the camera. A coding apparatus may compensate for the movement of the image of the physical body (motion compensation) so that the shape, the size, and the position of the image of the captured flat physical body are the same in each frame of the moving image.

MPEG-4 advanced simple profile (ASP), which is one of the moving image coding standards, employs a motion compensation method called global motion compensation (GMC). The coding apparatus determines a two-dimensional motion vector for each corner of the frame of the moving image to perform motion compensation.

FIG. 15 is a table relating to “no_of_sprite_warping_points”, being one of syntax elements. If a value of “no_of_sprite_warping_points” is 4, the coding apparatus uses projective transformation to perform global motion compensation. One two-dimensional motion vector has two parameters. Thus, the coding apparatus transmits 8 (=2×4) parameters to a decoding apparatus for each unit of processing in the global motion compensation. References 1 to 3 listed in FIG. 15 are as follows:

Reference 1: ISO/IEC 14496-2:2004 Information technology—Coding of audio-visual objects—Part 2: Visual
Reference 2: F. Zou, J. Chen, M. Karczewicz, X. Li, H.-C. Chuang, W.-J. Chien “Improved affine Motion Prediction”, JVET-00062, May 2016
Reference 3: M. Narroschke, R. Swoboda, “Extending HEVC by an affine motion model”, Picture coding symposium 2013

If the value of “no_of_sprite_warping_points” is 3, the coding apparatus uses affine transformation to perform motion compensation. The degree of freedom of affine transformation is also lower than the degree of freedom of projective transformation.

If the value of “no_of_sprite_warping_points” is 2, the coding apparatus uses similarity transformation to perform motion compensation. The degree of freedom of similarity transformation is lower than the degree of freedom of projective transformation.

Thus, a method of adaptively switching the value of “no_of_sprite_warping_points” between 2 and 3 has been proposed as a draft standard of joint exploration team on future video coding (JVET).

Motion compensation using a transformation equivalent to the affine transformation when the value of “no_of_sprite_warping_points” is 3 has been proposed. In H.264/advanced video coding (AVC) and H.265/high efficiency video coding (HEVC), the coding apparatus only performs motion compensation for a deformation of images of a physical body performing a translational movement (non-rotational movement) between frames. This motion compensation corresponds to a motion compensation when the value of “no_of_sprite_warping_points” is 1.

A relation expression of coordinates in a two-dimensional image (frame) of a flat physical body (rigid body) existing in a three-dimensional space, captured by a camera while the camera moves, can be expressed as in Equation (1).

$$\begin{matrix}[ Math . 1 ] & \\ ( \begin{matrix}{x}_{1}^{′} \\ {y}_{1}^{′} \\ {x}_{2}^{′} \\ {y}_{2}^{′} \\ {x}_{3}^{′} \\ {y}_{3}^{′} \\ {x}_{4}^{′} \\ {y}_{4}^{′}\end{matrix} ) = ( \begin{matrix}{x}_{1} & {y}_{1} & 1 & 0 & 0 & 0 & - {x}_{1} {x}_{1}^{′} & - {y}_{1} {x}_{1}^{′} \\ 0 & 0 & 0 & {x}_{1} & {y}_{1} & 1 & - {x}_{1} {y}_{1}^{′} & - {y}_{1} {y}_{1}^{′} \\ {x}_{2} & {y}_{2} & 1 & 0 & 0 & 0 & - {x}_{2} {x}_{2}^{′} & - {y}_{2} {x}_{2}^{′} \\ 0 & 0 & 0 & {x}_{2} & {y}_{2} & 1 & - {x}_{2} {y}_{2}^{′} & - {y}_{2} {y}_{2}^{′} \\ {x}_{3} & {y}_{3} & 1 & 0 & 0 & 0 & - {x}_{3} {x}_{3}^{′} & - {y}_{3} {x}_{3}^{′} \\ 0 & 0 & 0 & {x}_{3} & {y}_{3} & 1 & - {x}_{3} {y}_{3}^{′} & - {y}_{3} {y}_{3}^{′} \\ {x}_{4} & {y}_{4} & 1 & 0 & 0 & 0 & - {x}_{4} {x}_{4}^{′} & - {y}_{4} {x}_{4}^{′} \\ 0 & 0 & 0 & {x}_{4} & {y}_{4} & 1 & - {x}_{4} {y}_{4}^{′} & - {y}_{4} {y}_{4}^{′}\end{matrix} ) ( \begin{matrix}{h}_{11} \\ {h}_{12} \\ {h}_{13} \\ {h}_{21} \\ {h}_{22} \\ {h}_{23} \\ {h}_{31} \\ {h}_{32}\end{matrix} ) & ( 1 )\end{matrix}$$

FIG. 16 is a diagram illustrating an example of projective transformation on the basis of four motion vectors. When four points “(x₁, y₁), . . . , (x₄, y₄)” of a frame 400 correspond to four points “(x′1, y′1), . . . , (x′4, y′4)” of a frame 401, the coding apparatus may solve the linear equation of Equation (1) to derive “h₁₁, . . . , h₃₂”. Here, the four points “(x₁, y₁) . . . (x₄, y₄)” of the frame 400 do not have to be vertices of the frame 400 that is rectangular.

The coding apparatus performs projective transformation on the basis of “h₁₁, . . . , h₃₂” and Equations (2) to (5) to derive a point (x′, y′) of the frame 401 corresponding to a point (x, y) of the frame 400. The 3×3 matrix “H” in Equation (2) is a homography matrix.

$$\begin{matrix}[ Math . 2 ] & \\ H = ( \begin{matrix}{h}_{11} & {h}_{21} & {h}_{31} \\ {h}_{12} & {h}_{22} & {h}_{32} \\ {h}_{13} & {h}_{23} & 1\end{matrix} ) & ( 2 )\end{matrix}$$

$$\begin{matrix}[ Math . 3 ] & \\ ( \begin{matrix}{v}_{x} \\ {v}_{1} \\ {v}_{1}\end{matrix} ) = H ( \begin{matrix}x \\ y \\ 1\end{matrix} ) & ( 3 )\end{matrix}$$

$$\begin{matrix}[ Math . 4 ] & \\ {x}^{′} = {v}_{x} / {v}_{l} & ( 4 )\end{matrix}$$

$$\begin{matrix}[ Math . 5 ] & \\ {y}^{′} = {v}_{y} / {v}_{l} & ( 5 )\end{matrix}$$

Eight parameters (x′1, y′ 1, . . . , x′4, y′4) representing movement destinations of the four known points in the frame 400 are parameters needed by the coding apparatus to transform the point (x, y) into the point (x′, y′). This means that the number of variables “h₁₁, . . . , h₃₂” in the homography matrix H is eight, and that the global motion compensation of ASP in MPEG-4 is “no_of_sprite_warping_points=4 (number of parameters=8).

### CITATION LIST

### Non Patent Literature

NPL 1: “Versatile Video Coding (Draft 6)”, Joint Video Experts Team (JVET) of ITU-T SG16 WP3 and ISO/IEC JTC 1/SC 29/WG 11, 15th Meeting Gothenburg, S E, 3-12 Jul. 2019

### SUMMARY OF THE INVENTION

### Technical Problem

In this way, when an image of a flat physical body captured by a camera that is moving is deformed in accordance with, for example, a relative position of the camera and the physical body, the coding apparatus performs motion compensation using projective transformation on the basis of eight parameters. Furthermore, also when an image of a physical body in a still state having any shape captured by a camera at a fixed position is deformed in accordance with a camera parameter of the camera, the coding apparatus performs motion compensation using projective transformation on the basis of eight parameters.

However, physical deformation of a flat physical body is limited. Thus, the number of the degrees of freedom of physical deformation of the flat physical body are fewer than the number of the degrees of freedom of deformation that can be expressed by projective transformation (8 parameters).

FIG. 17 is a diagram illustrating an example of a flat plate (rigid body). FIGS. 18 to 23 are diagrams illustrating first to sixth examples of the deformation of the flat plate illustrated in FIG. 17. In FIGS. 17 to 23, the flat plate is represented by a plate having a check pattern (checkerboard). When the orientation of a camera at a fixed position changes in accordance with a camera parameter, the image of the flat plate illustrated in FIG. 17 is deformed in the same way as the images of the flat plate illustrated in FIGS. 18 and 19. When the positioning of a camera that moves changes, the image of the flat plate illustrated in FIG. 17 is rotated and contracted in the same way as the image of the flat plate illustrated in FIG. 20.

The flat plate illustrated in FIG. 17 is a rigid body, and thus, the abnormal deformation of the image of the flat plate illustrated in FIGS. 21 to 23 is clearly unnatural. However, the coding apparatus uses projective transformation with eight parameters (degrees of freedom) to express the deformation of the image of the flat plate illustrated in FIGS. 21 to 23. Thus, it may not be possible to improve the coding efficiency of an image in a coding apparatus of the related art. In other words, although a manner in which an object in a real space captured from substantially the same position is projected in an image is limited, a coding apparatus of the related art uses parameters that can express even a change in the manner of projection that is unlikely from the relationship between the object and an imaging apparatus. Thus, there is room for improvement in the coding efficiency.

In view of the above circumstances, an object of the present invention is to provide a coding method, a coding apparatus, and a program capable of improving the coding efficiency of an image.

### Means for Solving the Problem

One aspect of the present invention is a coding method for coding an image to be coded using a reference image, the coding method including identifying a reference area being a part of the reference image, the reference area corresponding to an area to be coded being an area obtained by dividing the image to be coded, and obtaining a predicted area with respect to the area to be coded, by prediction using the reference area, wherein the area to be coded and the reference area have different sizes and/or different shapes, and in the identifying, the reference area is identified by utilizing a difference between a manner of projection of an object corresponding to the area to be coded and a manner of projection of the object corresponding to the reference area, due to an operation performed on a camera when the image to be coded and the reference image are acquired.

One aspect of the present invention is a coding apparatus for coding an image to be coded using a reference image, the coding apparatus including an identification unit configured to identify a reference area being a part of the reference image, the reference area corresponding to an area to be coded being an area obtained by dividing the image to be coded, and a predictor configured to obtain a predicted area with respect to the area to be coded, by prediction using the reference area, wherein the area to be coded and the reference area have different sizes and/or different shapes, and the identification unit identifies the reference area by utilizing a difference between a manner of projection of an object corresponding to the area to be coded and a manner of projection of the object corresponding to the reference area, due to an operation performed on a camera when the image to be coded and the reference image are acquired.

One aspect of the present invention provides a program that causes a computer to operate as the coding apparatus mentioned above.

### Effects of the Invention

According to the present invention, it is possible to improve the coding efficiency of an image.

### BRIEF DESCRIPTION OF DRAWINGS

FIG. 1 is a diagram illustrating a configuration example of a coding apparatus according to the present embodiment.

FIG. 2 is a diagram illustrating a configuration example of a motion compensator according to the present embodiment.

FIG. 3 is a flowchart illustrating an operation example of the coding apparatus according to the present embodiment.

FIG. 4 is a flowchart illustrating an operation example of the motion compensator according to the present embodiment.

FIG. 5 is a diagram illustrating a positional relationship between a camera and an object to be imaged.

FIG. 6 is a diagram illustrating an image displayed on a screen of a camera.

FIG. 7 is a diagram for explaining processing for calculating a homography matrix “H” by using one parameter.

FIG. 8 is a diagram for explaining processing for calculating the homography matrix “H” by using one parameter.

FIG. 9 is a diagram for explaining processing for calculating the homography matrix “H” by using two parameters.

FIG. 10 is a diagram for explaining processing for calculating the homography matrix “H” by using two parameters.

FIG. 11 is a diagram for explaining processing for calculating the homography matrix “H” by using three parameters.

FIG. 12 is a diagram for explaining processing for calculating the homography matrix “H” by using three parameters.

FIG. 13 is a diagram for explaining processing for calculating the homography matrix “H” by using four parameters.

FIG. 14 is a diagram for explaining processing for calculating the homography matrix “H” by using four parameters.

FIG. 15 is a table relating to “no_of_sprite_warping_points”, being one of syntax elements.

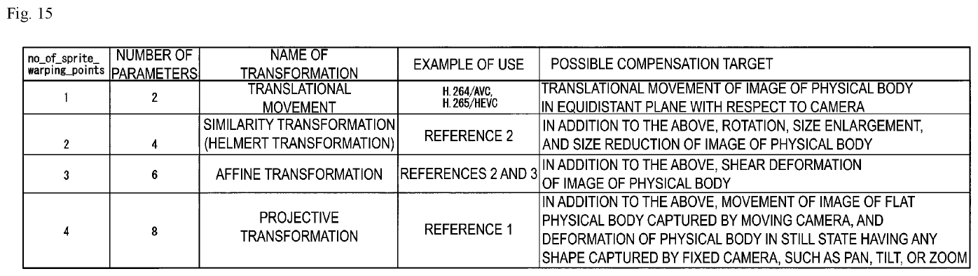

FIG. 16 is a diagram illustrating an example of projective transformation on the basis of four motion vectors.

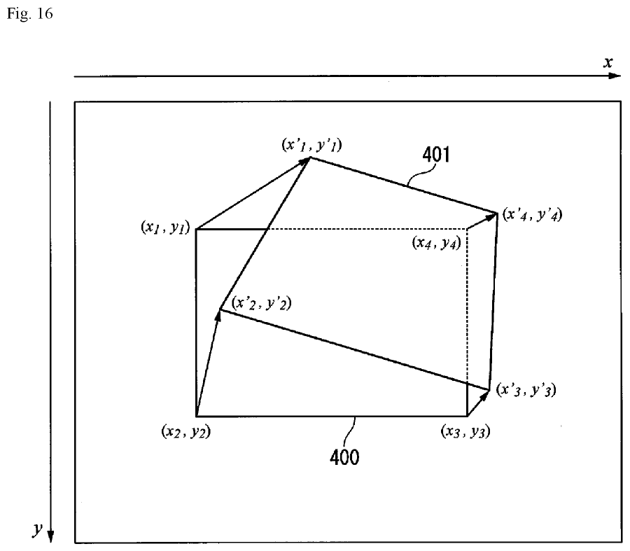

FIG. 17 is a diagram illustrating an example of a flat plate.

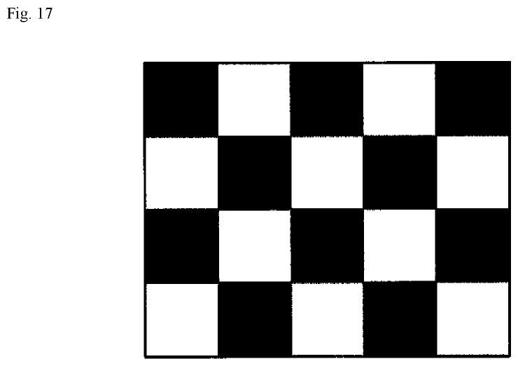

FIG. 18 is a diagram illustrating a first example of a deformation of the flat plate.

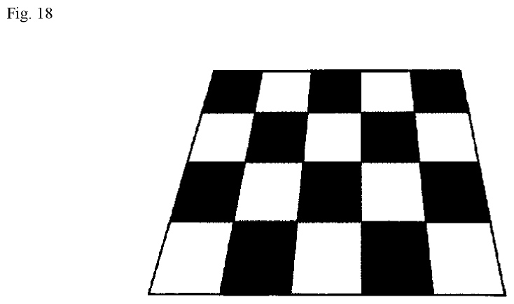

FIG. 19 is a diagram illustrating a second example of a deformation of the flat plate.

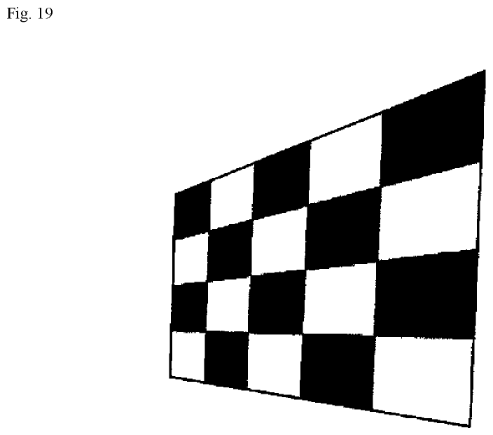

FIG. 20 is a diagram illustrating a third example of a deformation of the flat plate.

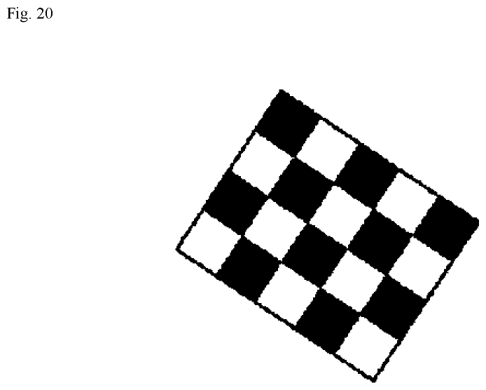

FIG. 21 is a diagram illustrating a fourth example of a deformation of the flat plate.

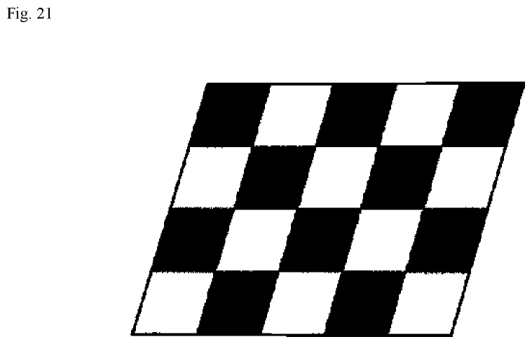

FIG. 22 is a diagram illustrating a fifth example of a deformation of the flat plate.

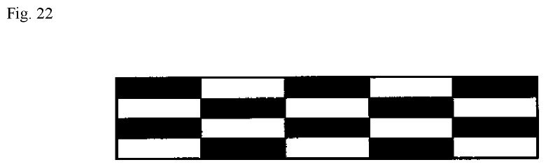

FIG. 23 is a diagram illustrating a sixth example of a deformation of the flat plate.

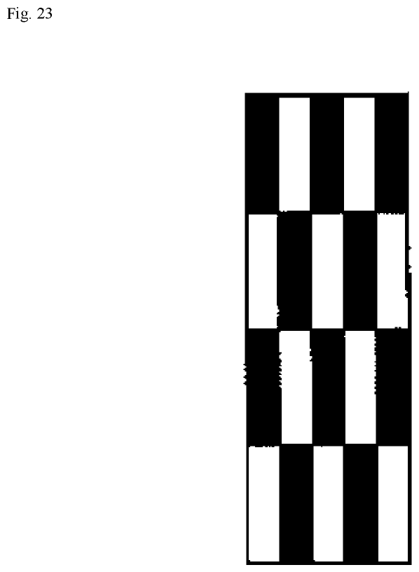

An embodiment of the present invention will be described below with reference to the drawings.

### Overview

In VVC (NPL 1), which is currently being standardized, it is not required that reference areas used at a time of predicting blocks to be coded have the same shape and size. This is because affine motion compensation prediction, that is expected to be implemented in VVC and later standards, can be utilized. However, the affine motion compensation prediction, that is expected to be implemented in VVC, uses motion vectors related to four vertices in the blocks to be coded to identify a reference area. When motion vectors related to the four vertices are used, eight parameters need to be used (because a motion vector defines a movement in an xy-plane). That is, eight parameters are transmitted to the decoding apparatus for each block to be coded. In VVC, eight parameters are used to identify the reference area, regardless of the relationship between the shape/size of the block to be coded and the shape/size of the reference area.

However, it is assumed that in some cases, the above-mentioned relationship can be identified without using eight parameters, and thus, there still remains a challenge in improvement of the coding efficiency. On the other hand, the coding apparatus uses projective transformation to express the deformation of the image of a physical body. The physical deformation of a physical body is limited, and thus, the coding apparatus uses projective transformation employing less than eight parameters (degrees of freedom) to express the deformation of images of the physical body in frames of a moving image. The coding apparatus can improve the coding efficiency of images by highly accurate motion compensation using projective transformation of any number N (N being an integer from 1 to 4) of parameters (degrees of freedom) less than eight parameters.

When the relationship mentioned above is broken down into subordinate concepts and organized, it is possible to reduce the number of parameters required for identification. Specifically, a minimum number of parameters required for identifying the relationship in shape and size is determined based on which of pan, tilt, roll, zoom and combinations thereof is a change (operation) performed on the camera from a time when an image to be coded is captured to a time when a reference image is captured. The relationship broken down into subordinate concepts can be derived from a change performed on the camera from a time when the image to be coded is captured to a time when the reference image is acquired, and thus, a camera parameter is utilized for estimating the relationship broken down into the subordinate concepts. In other words, for a correlation that is low due to a difference between a manner in which a predetermined object is projected in the image to be coded and a manner in which the predetermined object is projected in the reference image, the difference in the projecting manners is identified and corrected, so that the correlation is increased.

When the coding apparatus uses one parameter, one parameter obtained from any one of pan, tilt, roll, and zoom is used. When the coding apparatus uses two parameters, two parameters obtained from any two of pan, tilt, roll, and zoom are used. When the coding apparatus uses three parameters, three parameters obtained from any three of pan, tilt, roll, and zoom are used. When the coding apparatus uses four parameters, four parameters obtained from all of pan, tilt, roll, and zoom are used. The coding apparatus uses a camera parameter related to the image to be coded and a camera parameter related to the reference image to identify an operation performed on the camera and determine the number of parameters in accordance with the identified operation. Below, a specific configuration will be described.

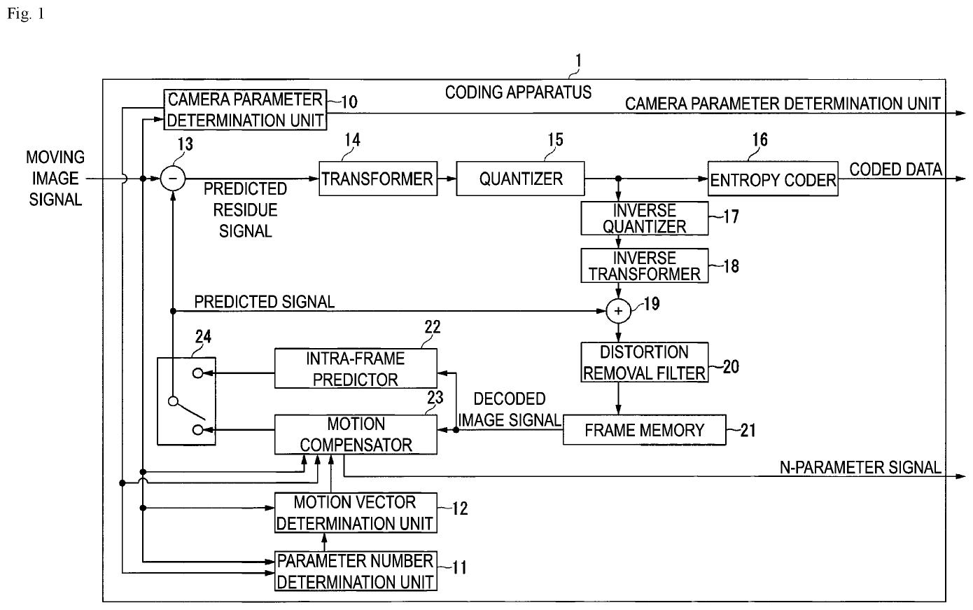

FIG. 1 is a diagram illustrating a configuration example of a coding apparatus 1. The coding apparatus 1 is an apparatus that encodes a moving image. A moving image input to the coding apparatus 1 is a moving image captured by a camera at a fixed installation position. The coding apparatus 1 encodes the moving image for each block obtained by dividing frames of the moving image. The coding apparatus 1 outputs coded data to a decoding apparatus. The coding apparatus 1 outputs a signal representing N parameters (hereinafter, referred to as an “N-parameter signal”) and a signal representing a camera parameter (hereinafter, referred to as a “camera parameter signal”) to an external apparatus (not illustrated) such as a decoding apparatus. Note that the coding apparatus 1 may include, in the N-parameter signal, information indicating whether or not the camera zooms.

The coding apparatus 1 includes a camera parameter determination unit 10, a parameter number determination unit 11, a motion vector determination unit 12, a subtractor 13, a transformer 14, a quantizer 15, an entropy coder 16, an inverse quantizer 17, an inverse transformer 18, an adder 19, a distortion removal filter 20, a frame memory 21, an intra-frame predictor 22, a motion compensator 23, and a switch 24.

Each functional unit other than the motion compensator 23 in the coding apparatus 1 may operate according to a well-known moving image coding standard such as “H.265/HEVC” and “H.264/AVC”. A part of the motion compensator 23 in the coding apparatus 1 may operate according to a well-known moving image coding standard.

A processor such as a central processing unit (CPU) or a graphics processing unit (GPU) executes a program stored in a memory which is a nonvolatile recording medium (non-transitory recording medium), and thus, a part or all of the coding apparatus 1 is achieved as software. A part or all of the coding apparatus 1 may be achieved by using hardware such as a large scale integration (LSI) or a field programmable gate array (FPGA).

The camera parameter determination unit 10 determines a camera parameter, based on a signal representing a moving image to be coded (hereinafter, referred to as a “moving image signal”). For example, the camera parameter determination unit 10 determines that an internal matrix A of a camera is a camera parameter A. The internal matrix A of the camera is represented by a 3×3 matrix indicating a focal length, a pixel size, and an image center of the camera. When a zoom function of the camera is utilized to capture a moving image, the focal length of the camera changes. Thus, when the zoom function of the camera is utilized to capture a moving image, the camera parameter determination unit 10 determines that an internal matrix A′ of the camera is a camera parameter A′. That is, when the zoom is not utilized, the camera parameter A′ is equal to A. The camera parameter determination unit 10 outputs a determination result of the camera parameter as the camera parameter signal to the outside, the parameter number determination unit 11, the motion vector determination unit 12, and the motion compensator 23.

The parameter number determination unit 11 determines the number of parameters required for projective transformation of the image to be coded represented by the moving image signal, based on the moving image signal and the camera parameter signal. The parameter number determination unit 11 uses a camera parameter related to the image to be coded and a camera parameter related to the reference image to identify an operation performed on the camera and determines the number of parameters in accordance with the identified operation. The motion vector determination unit 12 determines a motion vector, based on the moving image signal, the camera parameter signal, and the number of parameters. Specifically, the motion vector determination unit 12 outputs the motion vector, based on the number of parameters and a position in the image determined in advance according to the number of parameters. For example, when the number of parameters is 1 or 2, the motion vector determination unit 12 outputs a motion vector at the upper left corner of the image, and when the number of parameters is 3 or 4, the motion vector determination unit 12 outputs motion vectors at the upper left corner and the lower right corner of the image. Note that the positions in the image are not limited to those described above.

The subtractor 13 subtracts a predicted signal from the moving image signal. The predicted signal is generated for each predetermined unit of processing (area to be coded) by the intra-frame predictor 22 or the motion compensator 23. In H.265/HEVC, the predetermined unit of processing is a prediction unit. The subtractor 13 outputs a predicted residue signal resulting from the subtraction, to the transformer 14. The transformer 14 applies a discrete cosine transform to the predicted residue signal. The quantizer 15 quantizes a result of the discrete cosine transform. The entropy coder 16 performs entropy coding on a result of the quantization. The entropy coder 16 outputs coded data resulting from the entropy coding to an external apparatus (not illustrated) such as a decoding apparatus.

The inverse quantizer 17 performs inverse quantization on the result of the quantization. The inverse transformer 18 applies an inverse discrete cosine transform to a result of the inverse quantization. The adder 19 calculates a sum of a result of the inverse discrete cosine transform and the predicted signal to generate a decoded image. The distortion removal filter 20 removes a distortion from the decoded image to generate a decoded image signal from which the distortion is removed.

The frame memory 21 stores the decoded image signal (reference image) from which the distortion is removed. The decoded image signal stored in the frame memory 21 is the same as the decoded image signal generated by the decoding apparatus. The frame memory 21 deletes a decoded image signal that is stored for a time equal to or longer than a predetermined time, from the frame memory 21. Note that the frame memory 21 may store a decoded image signal of a long-time reference frame until the frame memory 21 acquires a deletion instruction. The frame memory 21 may not store the decoded image signal of a frame that is not used as a reference.

The intra-frame predictor 22 executes intra-frame prediction processing on the decoded image signal to generate a predicted signal according to a result of the intra-frame prediction processing. The motion compensator 23 executes motion compensation prediction processing on the decoded image signal to generate a predicted signal according to a result of the motion compensation prediction processing. For example, the motion compensator 23 identifies a reference area that is a part of the reference image represented by the decoded image signal and makes a prediction using the reference area to obtain a predicted area with respect to the area to be coded. The area to be coded and the reference area have different sizes and/or different shapes. The switch 24 outputs, to the subtractor 13, a predicted signal according to the result of the intra-frame prediction processing. The switch 24 outputs, to the subtractor 13, a predicted signal according to the result of the motion compensation prediction processing.

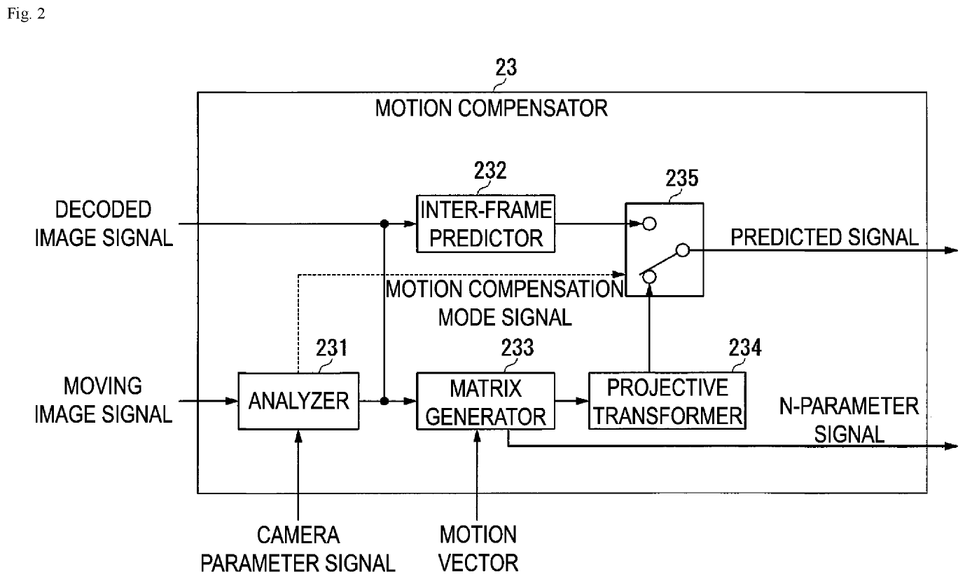

Next, a configuration example of the motion compensator 23 will be described. FIG. 2 is a diagram illustrating a configuration example of the motion compensator 23. The motion compensator 23 includes an analyzer 231, an inter-frame predictor 232, a matrix generator 233, a projective transformer 234, and a switch 235.

Motion compensation modes include a first mode and a second mode. The first mode is a motion compensation mode on the basis of inter-frame prediction processing in a well-known moving image coding standard such as “H.265/HEVC” and “H.264/AVC”. The second mode is a motion compensation mode in which a homography matrix on the basis of one or more motion vectors (the N-parameter signal) is used to execute projective transformation for each unit of projective transformation on the decoded image signal stored in the frame memory 21.

The analyzer 231 acquires a plurality of frames (hereinafter, referred to as a “frame group”) of the moving image in a predetermined time period (time interval) as the moving image signal. Furthermore, the analyzer 231 acquires a camera parameter signal for each frame from the camera parameter determination unit 10. The analyzer 231 determines whether or not the acquired frame group is a frame group captured in a time period during which the camera parameter is constant. The accuracy of the projective transformation using the homography matrix is high for a frame group captured in a time period during which the camera parameter is constant, and thus, the second mode motion compensation is more suitable than the first mode motion compensation.

When the analyzer 231 determines that the frame group is a frame group captured in a time period during which the camera parameter is not constant, the analyzer 231 generates a motion compensation mode signal representing the first mode (hereinafter, referred to as a “first motion compensation mode signal”). The analyzer 231 outputs the first motion compensation mode signal to the inter-frame predictor 232 and the switch 235.

When the analyzer 231 determines that the frame group is a frame group captured in a time period during which the camera parameter is constant, the analyzer 231 generates a motion compensation mode signal representing the second mode (hereinafter, referred to as a “second motion compensation mode signal”). The analyzer 231 outputs the second motion compensation mode signal to the matrix generator 233 and the switch 235.

When the inter-frame predictor 232 acquires the first motion compensation mode signal from the analyzer 231, the inter-frame predictor 232 acquires the decoded image signal from the frame memory 21. The inter-frame predictor 232 acquires the moving image signal from the analyzer 231. The inter-frame predictor 232 executes motion compensation on the basis of the inter-frame prediction processing in a well-known moving image coding standard, with respect to the decoded image signal. The inter-frame predictor 232 outputs a predicted signal on the basis of the first mode motion compensation, to the switch 235.

When the matrix generator 233 acquires the second motion compensation mode signal from the analyzer 231, the matrix generator 233 acquires the frame group and the camera parameter signal from the analyzer 231. When the matrix generator 233 acquires the second motion compensation mode signal from the analyzer 231, the matrix generator 233 acquires the decoded image signal from the frame memory 21. When the matrix generator 233 acquires the second motion compensation mode signal from the analyzer 231, the matrix generator 233 acquires the motion vector from the motion vector determination unit 12.

The matrix generator 233 outputs the N-parameter signal for each frame to an external apparatus (not illustrated) such as a decoding apparatus and the projective transformer 234. The matrix generator 233 outputs the N-parameter signal to an external apparatus (not illustrated) such as a decoding apparatus and the projective transformer 234, for each unit of projective transformation defined in the decoded image. The external apparatus such as the decoding apparatus may use the output camera parameter signal and the output N-parameter signal to derive a homography matrix. The matrix generator 233 uses the camera parameter signal and the motion vector to generate a homography matrix “H”. For example, the matrix generator 233 identifies the reference area by utilizing a difference between a manner of projection of an object corresponding to the area to be coded and a manner of projection of the object corresponding to the reference area, due to an operation performed on the camera. The operations performed on the camera are the above-described pan, tilt, roll, and zoom.

The projective transformer 234 executes projective transformation using the homography matrix “H” on the decoded image signal stored in the frame memory 21. The projective transformer 234 outputs a predicted signal on the basis of the second mode motion compensation to the switch 235.

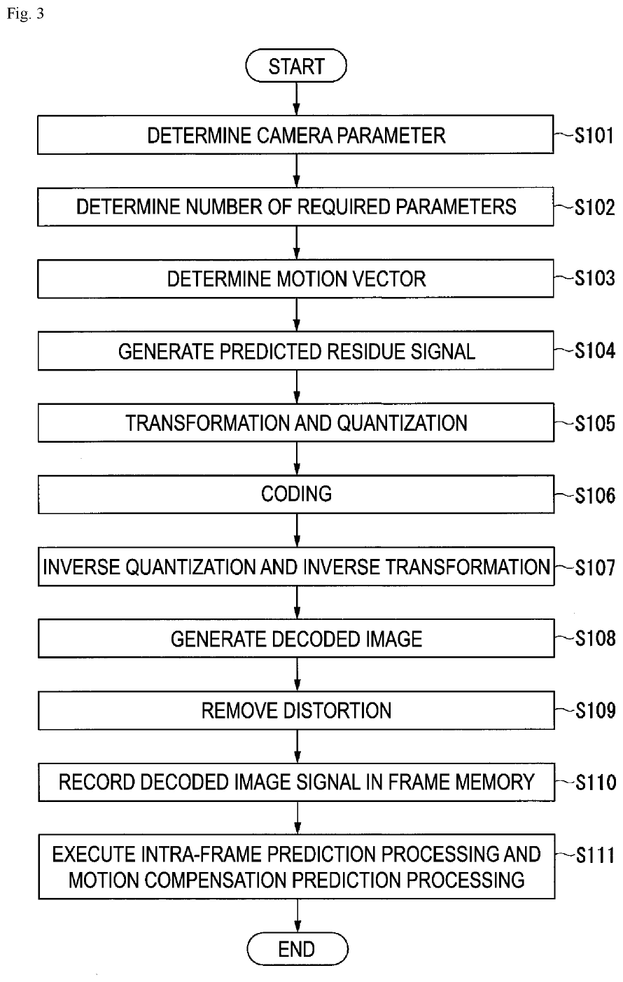

FIG. 3 is a flowchart illustrating an operation example of the coding apparatus 1. The camera parameter determination unit 10 determines a camera parameter, based on a signal representing an input moving image (hereinafter, referred to as a “moving image signal”) (step S101). The camera parameter determination unit 10 outputs the camera parameter to the outside, the parameter number determination unit 11, and the motion vector determination unit 12. The parameter number determination unit 11 determines the number of parameters required for the projective transformation, based on the moving image signal and the camera parameter signal (step S102). The parameter number determination unit 11 outputs a determination result of the number of parameters, to the motion vector determination unit 12. For example, when the parameter number determination unit 11 determines that the number of parameters required for the projective transformation is “1”, the parameter number determination unit 11 outputs a determination result including information that the number of parameters is “1”, to the motion vector determination unit 12.

The motion vector determination unit 12 determines a motion vector, based on the moving image signal, the camera parameter signal, and the number of parameters (step S103). The motion vector determination unit 12 outputs a determination result of the motion vector to the motion compensator 23. The subtractor 13 generates a predicted residue signal (step S104). The transformer 14 applies a discrete cosine transform to the predicted residue signal. The quantizer 15 quantizes a result of the discrete cosine transform (step S105). The entropy coder 16 performs entropy coding on a result of the quantization (step S106).

The inverse quantizer 17 performs inverse quantization on the result of the quantization. The inverse transformer 18 applies an inverse discrete cosine transform to a result of the inverse quantization (step S107). The adder 19 calculates a sum of a result of the inverse discrete cosine transform and the predicted signal to generate a decoded image (step S108). The distortion removal filter 20 removes a distortion from the decoded image to generate a decoded image signal from which the distortion is removed (step S109).

The distortion removal filter 20 records the decoded image signal in the frame memory 21 (step S110). The intra-frame predictor 22 executes intra-frame prediction processing on the decoded image signal to generate a predicted signal according to a result of the intra-frame prediction processing. The motion compensator 23 executes motion compensation prediction processing on the decoded image signal to generate a predicted signal according to a result of the motion compensation prediction processing (step S111).

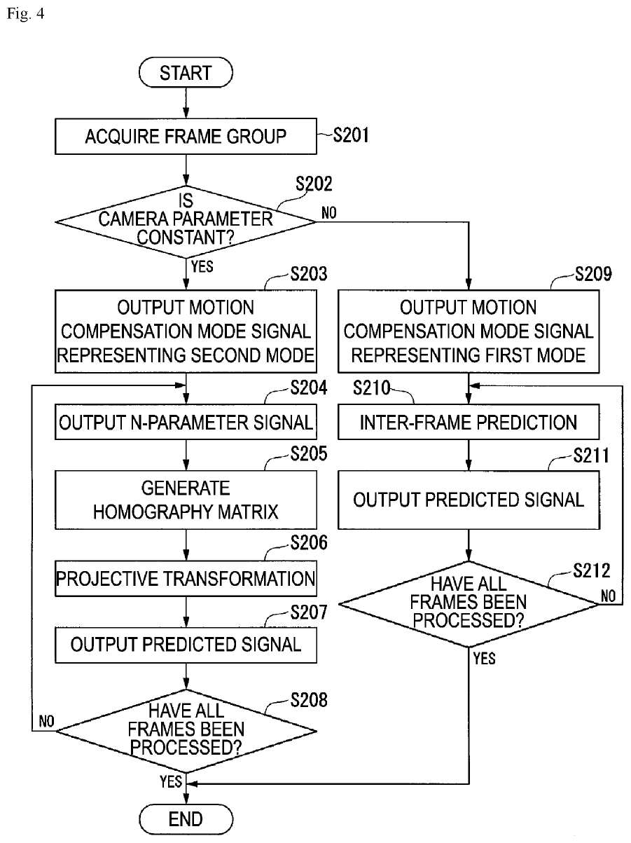

FIG. 4 is a flowchart illustrating an operation example of the motion compensator 23.

The analyzer 231 acquires a frame group and a camera parameter signal (step S201). The analyzer 231 determines whether or not the acquired frame group is a frame group captured in a time period during which a camera parameter “B” is constant (step S202). When the analyzer 231 determines that the acquired frame group is a frame group captured in a time period during which the camera parameter “B” is constant (step S202: YES), the analyzer 231 outputs the second motion compensation mode signal to the matrix generator 233 and the switch 235 (step S203).

The matrix generator 233 outputs the N-parameter signal for each frame to an external apparatus (not illustrated) such as a decoding apparatus (step S204). Furthermore, the matrix generator 233 outputs the N-parameter signal to an external apparatus (not illustrated) such as a decoding apparatus, for each unit of projective transformation (prediction unit) defined in the decoded image.

The matrix generator 233 uses the camera parameter signal, the decoded image signal, and the motion vector to generate the homography matrix “H” (step S205).

First, equations utilized in the following description will be described. Rotation matrices when the camera performs each of tilt (a rotation about the x-axis), pan (a rotation about the y-axis), and roll (a rotation around the z-axis) are expressed by Equations (6) below.

$$\begin{matrix}[ Math . 6 ] & \\ {R}_{x} ( {θ}_{x} ) = ( \begin{matrix}1 & 0 & 0 \\ 0 & cos {θ}_{x} & sin {θ}_{x} \\ 0 & - sin {θ}_{x} & cos {θ}_{x}\end{matrix} ) \\ {R}_{y} ( {θ}_{y} ) = ( \begin{matrix}cos {θ}_{y} & 0 & - sin {θ}_{y} \\ 0 & 1 & 0 \\ sin {θ}_{y} & 0 & cos {θ}_{y}\end{matrix} ) \\ {R}_{z} ( {θ}_{z} ) = ( \begin{matrix}cos {θ}_{z} & sin {θ}_{z} & 0 \\ - sin {θ}_{z} & cos {θ}_{z} & 0 \\ 0 & 0 & 1\end{matrix} ) & ( 6 )\end{matrix}$$

θₓ in Equation (6) represents a rotation angle in the x-axis direction. θ_{y} represents a rotation angle in the y-axis direction. θ_{z} represents a rotation angle in the z-axis direction. Furthermore, the camera parameter A is expressed by Equation (7) below.

$$\begin{matrix}[ Math . 7 ] & \\ A = ( \begin{matrix}{f}_{x} & 0 & {o}_{x} \\ 0 & {f}_{y} & {o}_{y} \\ 0 & 0 & 1\end{matrix} ) & ( 7 )\end{matrix}$$

In Equation (6), oₓ represents a half of a horizontal image size, o_{y} represents a half of a vertical image size, fₓ and f_{y} are determined from the focal length and the vertical and horizontal size of the pixels in the imaging plane, and normally, fₓ=f_{y}=f is satisfied. A space rotation amount R is expressed by Equation (8) below using Equations (6).

[Math. 8]

R=Rₓ(θₓ)R_{y}(θ_{y})R_{z}(θ_{z}) (8)

The matrix generator 233 generates the homography matrix “H”, based on Equation (9) below.

$$\begin{matrix}[ Math . 9 ] & \\ ( \begin{matrix}{v}_{x} \\ {v}_{y} \\ {v}_{1}\end{matrix} ) = {A}^{′} {RA}^{- 1} ( \begin{matrix}x \\ y \\ 1\end{matrix} ) & ( 9 )\end{matrix}$$

A′RA⁻¹ in Equation (9) corresponds to the homography matrix “H”. Note that, when the zoom is not utilized in capturing the image to be coded, A′ in Equation (9) is the camera parameter A. In Equation (9), a point (x, y) in the decoded image signal corresponds to a point (vₓ/v₁, v_{y}/v₁) in the moving image signal.

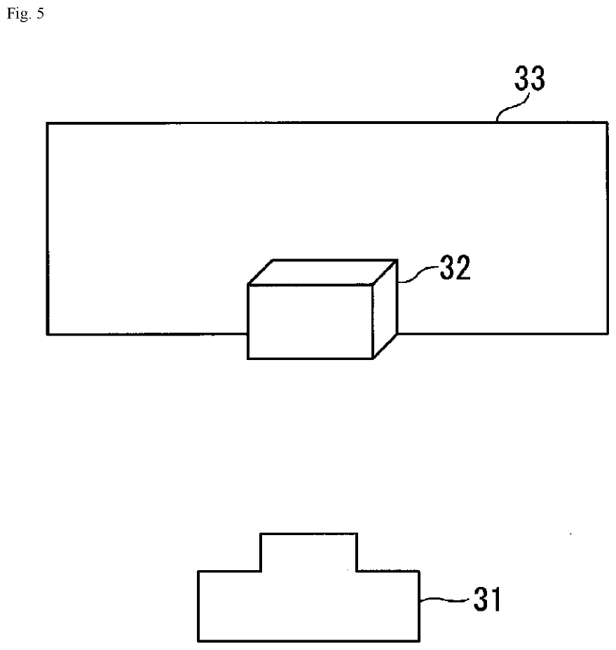

Next, a specific processing for generating the homography matrix “H” by the matrix generator 233 will be described with reference to FIGS. 5 to 14.

FIG. 5 is a diagram illustrating a positional relationship between a camera 31 and an object 32. As illustrated in FIG. 5, the camera 31 is fixedly installed in front of the object 32. In the example illustrated in FIG. 5, it is assumed that the camera 31 is not panned, tilted, rolled, or zoomed. Note that, when an imaging position of the camera 31 is fixed during the capturing of the moving image, the camera 31 may image the object 32 from a position where the object 32 can be imaged by the camera 31. When a moving image is captured by the camera 31 in a positional relationship illustrated in FIG. 5, the object 32 and a background 33 are imaged.

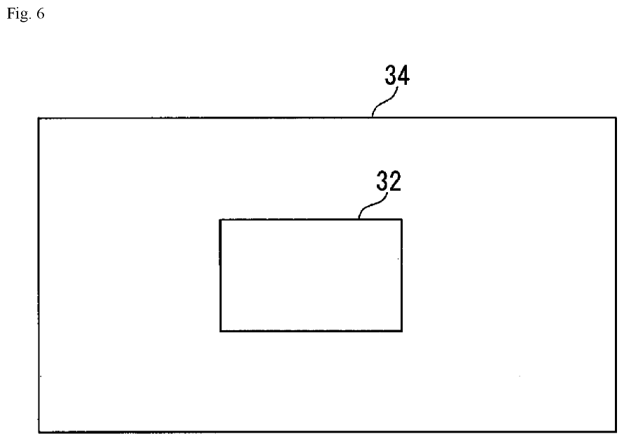

FIG. 6 is a diagram illustrating an image displayed on a screen 34 of the camera 31. When the camera 31 is not panned, tilted, rolled, or zoomed, a moving image obtained by imaging the object 32 from the front as illustrated in FIG. 6 is displayed on the screen 34.

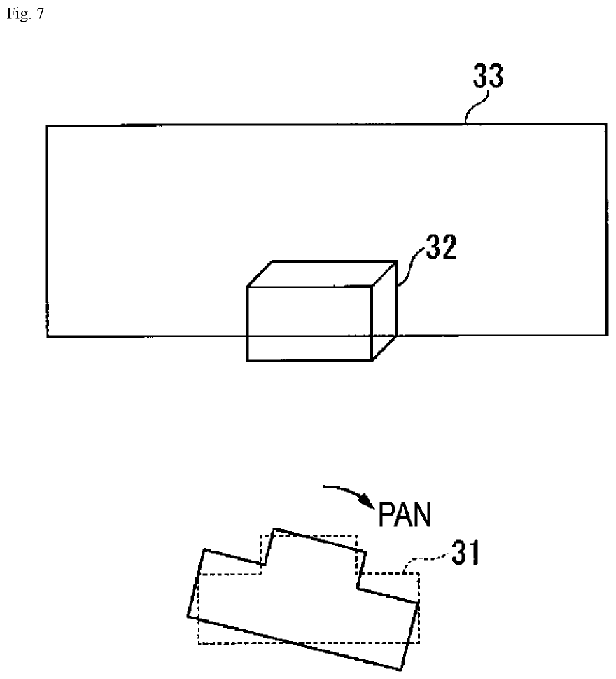

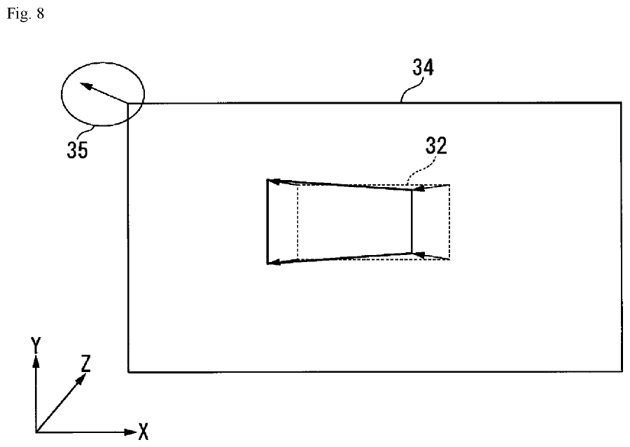

FIGS. 7 and 8 are diagrams for explaining processing for calculating the homography matrix “H” by using one parameter. Note that in FIGS. 7 and 8, a case where a pan operation is performed on the camera will be described as an example. However, in the processing for calculating the homography matrix “H” by using one parameter, only a tilt operation may be performed on the camera, only a roll operation may be performed on the camera, or only a zoom operation may be performed on the camera.

As illustrated in FIG. 7, the camera 31 is installed with a fixed orientation in a state of being turned to the right with respect to the object 32 when viewed from the camera 31. When a moving image is captured by the camera 31 in a positional relationship illustrated in FIG. 7, the object 32 is imaged as illustrated in FIG. 8. Here, when the matrix generator 233 acquires a motion vector (it is sufficient to acquire only an x-component) of an upper left origin point (0, 0) (a motion vector indicated by a circle 35 in FIG. 8) from the motion vector determination unit 12, the matrix generator 233 generates the homography matrix “H”, based on Equation (10) below.

$$\begin{matrix}[ Math . 10 ] & \\ ( \begin{matrix}{v}_{x} \\ {v}_{y} \\ {v}_{1}\end{matrix} ) = A ( \begin{matrix}cos θ & 0 & - sin θ \\ 0 & 1 & 0 \\ sin θ & 0 & cos θ\end{matrix} ) {A}^{- 1} ( \begin{matrix}0 \\ 0 \\ 1\end{matrix} ) = ( \begin{matrix}{o}_{x} ( cos θ - \frac{{o}_{x} sin θ}{f} ) + f ( - \frac{{o}_{x} cos θ}{f} - sin θ ) \\ {o}_{y} ( cos θ - \frac{{o}_{x} sin θ}{f} ) - {o}_{y} \\ cos θ - \frac{{o}_{x} sin θ}{f}\end{matrix} ) & ( 10 )\end{matrix}$$

$$\frac{{v}_{x}}{{v}_{1}} = ( {o}_{x}^{2} sin θ + {f}^{2} sin θ ) / ( {o}_{x} sin θ + f cos θ ) \\ A = ( \begin{matrix}f & 0 & {o}_{x} \\ 0 & f & {o}_{y} \\ 0 & 0 & 1\end{matrix} )$$

In Equation (10), vₓ/v₁ is the x-component of the motion vector of the origin point, and thus, the matrix generator 233 solves Equation (10) to obtain θ (or sin θ and cos θ) to generate the homography matrix “H” (ARA⁻¹) on the entire screen. Note that a movement of the upper left origin point is focused on in FIG. 8, but the movement may be a movement of any one point on the screen. Thus, when any one of pan, tilt, roll, and zoom operations is performed on the camera 31, the matrix generator 233 identifies a reference area by using a parameter expressed in one dimension. Specifically, the matrix generator 233 uses a one-dimensional component of the motion vector at one specific point of the image to be coded, a camera parameter at a time when the image to be coded is acquired, and a camera parameter at a time when the reference image is acquired to generate the homography matrix “H” and uses the generated homography matrix “H” to identify the reference area.

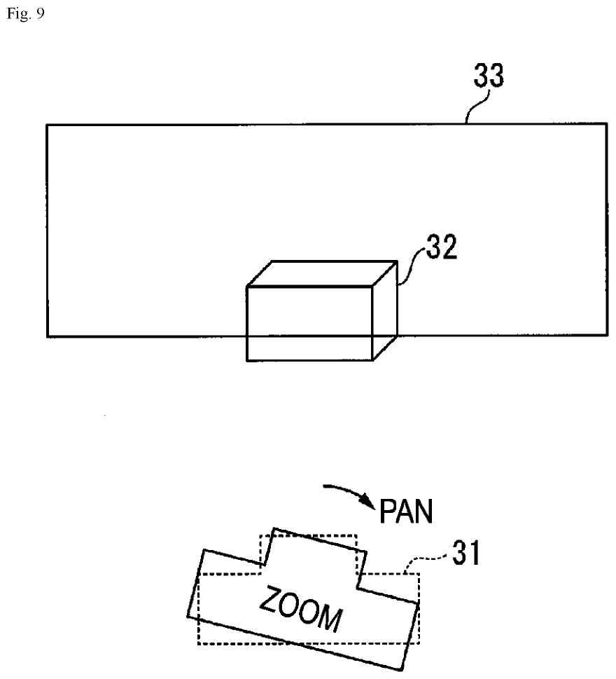

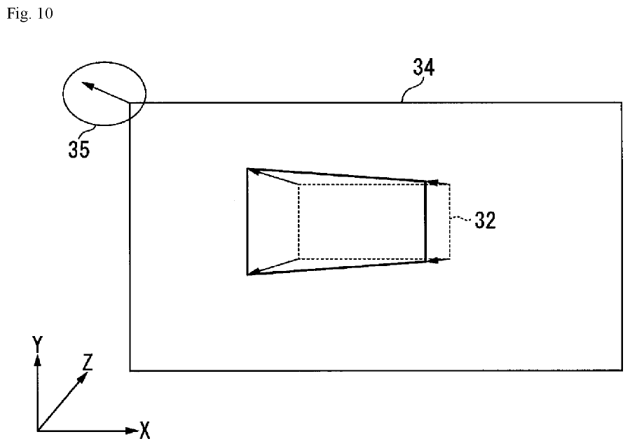

FIGS. 9 and 10 are diagrams for explaining processing for calculating the homography matrix “H” by using two parameters. Note that in FIGS. 9 and 10, a case where two operations, a pan operation and a zoom operation, are performed on the camera will be described as an example. However, in the processing for calculating the homography matrix “H” by using two parameters, the two operations are not limited to the combination mentioned above, and any combination may be used, as long as the combination being used is a combination of any two operations of the pan operation, the tilt operation, the roll operation, and the zoom operation.

As illustrated in FIG. 9, it is assumed that the camera 31 is installed with a fixed orientation in a state of being turned to the right with respect to the object 32 when viewed from the camera 31, and a zoom operation is performed. When a moving image is captured by the camera 31 in a positional relationship illustrated in FIG. 9, the object 32 is imaged as illustrated in FIG. 10. Here, when the matrix generator 233 acquires a motion vector (x-component and y-component) of an upper left origin point (0, 0) (a motion vector indicated by a circle 35 in FIG. 10) from the motion vector determination unit 12, the matrix generator 233 generates the homography matrix “H”, based on Equation (11) below.

$$\begin{matrix}[ Math . 11 ] & \\ ( \begin{matrix}{v}_{x} \\ {v}_{y} \\ {v}_{1}\end{matrix} ) = {A}^{′} {R}_{y} ( θ ) {A}^{- 1} ( \begin{matrix}0 \\ 0 \\ 1\end{matrix} ) \\ A = ( \begin{matrix}f & 0 & {o}_{x} \\ 0 & f & {o}_{y} \\ 0 & 0 & 1\end{matrix} ) A ' = ( \begin{matrix}{f}^{′} & 0 & {o}_{x} \\ 0 & {f}^{′} & {0}_{y} \\ 0 & 0 & 1\end{matrix} ) & ( 11 )\end{matrix}$$

In Equation (11), (vₓ/v₁, v_{y}/v₁) is a motion vector of the origin point, and thus, the matrix generator 233 solves Equation (11) to obtain θ (or sin θ and cos θ) and f to generate the homography matrix “H” (A′RA⁻¹) on the entire screen. f′ in Equation (11) is expressed as f=s*f Here, s is a value representing a change ratio off, s>1 in the case of zooming in, and s<1 in the case of zooming out. Note that a movement of the upper left origin point is focused on in FIG. 10, but the movement may be a movement of any one point on the screen. Furthermore, when two parameters are used, the motion vector of the upper left origin point (0, 0) (it is sufficient to use only the x-component) and a motion vector of a lower right point (2x, 2y) (it is sufficient to use only an x-component) may be used, for example.

Thus, when two of pan, tilt, roll, and zoom operations are performed on the camera 31, the matrix generator 233 identifies the reference area by using a combination of parameters expressed in one dimension or a parameter expressed in two dimensions. Specifically, when two-dimensional components of a motion vector at one specific point of the image to be coded are used, the matrix generator 233 uses the two-dimensional components, a camera parameter at a time when the image to be coded is acquired, and a camera parameter at a time when the reference image is acquired to generate the homography matrix “H” and uses the generated homography matrix “H” to identify the reference area, and when one-dimensional components (for example, only x-components) of the respective motion vectors at two specific points of the image to be coded are used, the matrix generator 233 uses the plurality of one-dimensional components, a camera parameter at a time when the image to be coded is acquired, and a camera parameter at a time when the reference image is acquired to generate the homography matrix “H” and uses the generated homography matrix “H” to identify the reference area. When two or more parameters are used, it is preferable to select farthest possible parameters from each other in one image plane.

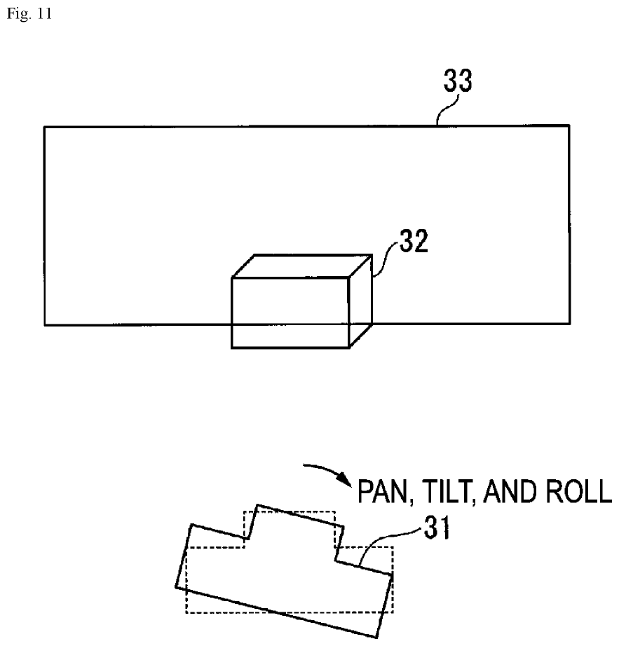

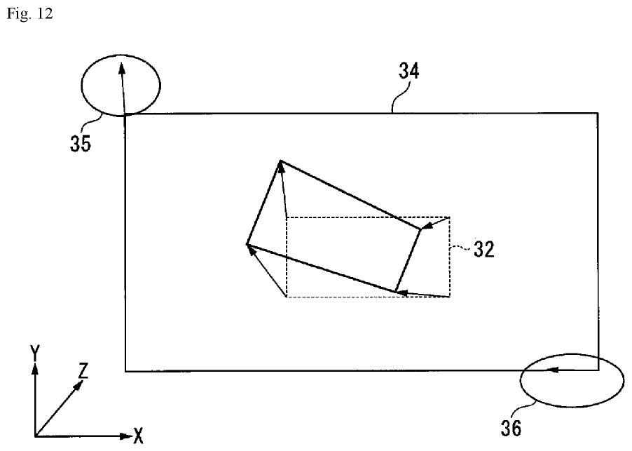

FIGS. 11 and 12 are diagrams for explaining processing for calculating the homography matrix “H” by using three parameters. Note that in FIGS. 11 and 12, a case where three operations, a pan operation, a tilt operation, and a roll operation, are performed on the camera will be described as an example. However, in the processing for calculating the homography matrix “H” by using three parameters, the three operations are not limited to the combination mentioned above, and any combination may be used, as long as the combination being used is a combination of any three operations of the pan operation, the tilt operation, the roll operation, and the zoom operation.

As illustrated in FIG. 11, the camera 31 is installed with a fixed orientation in a state of being panned to the right with respect to the object 32, when viewed from the camera 31, and tilted and rolled. When a moving image is captured by the camera 31 in a positional relationship illustrated in FIG. 11, the object 32 is imaged as illustrated in FIG. 12. Here, when the matrix generator 233 acquires a motion vector of an upper left origin point (0, 0) (a motion vector indicated by a circle 35 in FIG. 12) and a motion vector (it is sufficient to acquire only an x-component) of a lower right corner point (2ox, 2oy) (a motion vector indicated by a circle 36 in FIG. 12) from the motion vector determination unit 12, the matrix generator 233 generates the homography matrix “H”, based on Equations (12) below.

$$\begin{matrix}[ Math . 12 ] & \\ ( \begin{matrix}{v}_{x 1} \\ {v}_{y 1} \\ {v}_{11}\end{matrix} ) = {A}^{′} {R}_{y} ( θ ) {A}^{- 1} ( \begin{matrix}0 \\ 0 \\ 1\end{matrix} ) \\ ( \begin{matrix}{v}_{x 2} \\ {v}_{y 2} \\ {v}_{12}\end{matrix} ) = {A}^{′} {R}_{x} ( {θ}_{x} ) {R}_{y} ( {θ}_{y} ) {R}_{z} ( {θ}_{z} ) {A}^{- 1} ( \begin{matrix}2 {o}_{x} \\ 0 \\ 1\end{matrix} ) \\ A = ( \begin{matrix}f & 0 & {o}_{x} \\ 0 & f & {o}_{y} \\ 0 & 0 & 1\end{matrix} ) A ' = ( \begin{matrix}{f}^{′} & 0 & {o}_{x} \\ 0 & {f}^{′} & {0}_{y} \\ 0 & 0 & 1\end{matrix} ) & ( 12 )\end{matrix}$$

In Equations (12), (vₓ₁/v₁₁, vᵣ₁/v₁₁) and (vₓ₂/v₁₂, v_{y2}/v₁₂) are motion vectors in the upper left corner and the lower right corner of the screen, and thus, the matrix generator 233 solves Equations (12) to obtain θ, θ_{y}, and θ_{z} (or the sines and cosines of θ, θ_{y}, and θ_{z} and f′, to generate the homography matrix “H” (A′RA⁻¹) on the entire screen. Thus, when three of pan, tilt, roll, and zoom operations are performed on the camera 31, the matrix generator 233 identifies the reference area by using a parameter expressed in one dimension and a parameter expressed in two dimensions. Specifically, the matrix generator 233 uses two-dimensional components (x-component and y-component) of a motion vector at one of two specific points of an image to be coded, a one-dimensional component (for example, only the x-component) of a motion vector at the other one of the two specific points, a camera parameter at a time when the image to be coded is acquired, and a camera parameter at a time when the reference image is acquired to generate the homography matrix “H”, and uses the generated homography matrix “H” to identify the reference area.

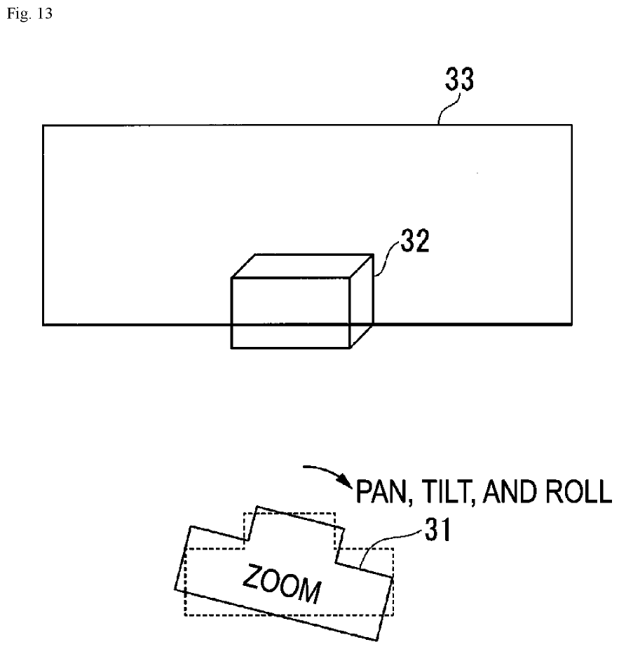

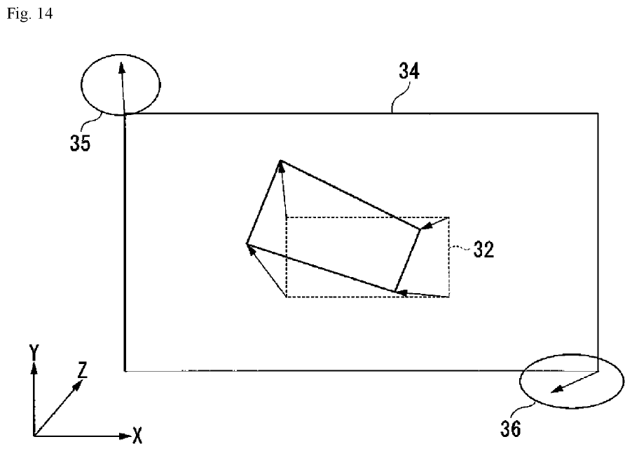

FIGS. 13 and 14 are diagrams for explaining processing for calculating the homography matrix “H” by using four parameters. Note that in FIGS. 13 and 14, a case where all of the pan operation, the tilt operation, the roll operation, and the zoom operation are performed on the camera will be described as an example.

As illustrated in FIG. 13, it is assumed that the camera 31 is installed with a fixed orientation in a state of being panned to the right with respect to the object 32, when viewed from the camera 31, and tilted and rolled, and a zoom operation is performed. When a moving image is captured by the camera 31 in a positional relationship illustrated in FIG. 13, the object 32 is imaged as illustrated in FIG. 14. Here, when the matrix generator 233 acquires a motion vector of an upper left origin point (0, 0) (a motion vector indicated by a circle 35 in FIG. 14) and a motion vector of a lower right corner point (2ox, 2oy) (a motion vector indicated by a circle 36 in FIG. 14) from the motion vector determination unit 12, the matrix generator 233 generates the homography matrix “H”, based on Equations (13) below.

$$\begin{matrix}[ Math . 13 ] & \\ ( \begin{matrix}{v}_{x 1} \\ {v}_{y 1} \\ {v}_{11}\end{matrix} ) = {A}^{′} {R}_{y} ( θ ) {A}^{- 1} ( \begin{matrix}0 \\ 0 \\ 1\end{matrix} ) \\ ( \begin{matrix}{v}_{x 2} \\ {v}_{y 2} \\ {v}_{12}\end{matrix} ) = {A}^{′} {R}_{x} ( {θ}_{x} ) {R}_{y} ( {θ}_{y} ) {R}_{z} ( {θ}_{z} ) {A}^{- 1} ( \begin{matrix}2 {o}_{x} \\ 2 {o}_{y} \\ 1\end{matrix} ) \\ A = ( \begin{matrix}f & 0 & {o}_{x} \\ 0 & f & {o}_{y} \\ 0 & 0 & 1\end{matrix} ) A ' = ( \begin{matrix}{f}^{′} & 0 & {o}_{x} \\ 0 & {f}^{′} & {0}_{y} \\ 0 & 0 & 1\end{matrix} ) & ( 13 )\end{matrix}$$

In Equations (13), (vₓ₁/v₁₁, vᵣ₁/v₁₁)) and (vₓ₂/v₁₂, v_{y2}/v₁₂) are motion vectors in the upper left corner and the lower right corner of the screen, and thus, the matrix generator 233 solves Equations (13) to obtain θ, θ_{y}, and θz (or the sines and cosines of θ, θ_{y}, and θ_{z} and f′, to generate the homography matrix “H” (A′RA⁻¹) on the entire screen. In the example of FIG. 14, movements of the upper left point and the lower right point are focused upon, but the movements may be movements of an upper right point and a lower left point that are separated from each other. It is important that such points are far from each other. Thus, when all of pan, tilt, roll, and zoom operations are performed on the camera 31, the matrix generator 233 identifies the reference area by using a plurality of parameters expressed in two dimensions. Specifically, the matrix generator 233 uses two-dimensional components of motion vectors at the respective two specific points of the image to be coded, a camera parameter at a time when the image to be coded is acquired, and a camera parameter at a time when the reference image is acquired to generate the homography matrix “H” and uses the generated homography matrix “H” to identify the reference area.

The projective transformer 234 executes the second mode motion compensation on the decoded image signal stored in the frame memory 21 by performing projective transformation using the homography matrix “H” (step S206). The projective transformer 234 outputs a predicted signal on the basis of the second mode motion compensation to the switch 235. The switch 235 outputs the predicted signal on the basis of the second mode motion compensation to the subtractor 13 (step S207).

The projective transformer 234 determines whether or not the second mode motion compensation is executed for all the frames in the acquired frame group (step S208). When the projective transformer 234 determines that there is a frame for which the second mode motion compensation is not yet executed (step S208: NO), the projective transformer 234 returns the processing to step S204. When the projective transformer 234 determines that the second mode motion compensation has been executed for all of the frames (step S208: YES), the matrix generator 233 and the projective transformer 234 terminate the motion compensation processing for the acquired frame group.

When the frame group is a frame group captured in a time period during which the camera parameter “B” is not constant (a frame group suitable for well-known inter-frame prediction processing) (step S202: NO), the analyzer 231 outputs the first motion compensation mode signal to the inter-frame predictor 232 and the switch 235 (step S209).

The inter-frame predictor 232 executes motion compensation on the basis of the inter-frame prediction processing in a well-known moving image coding standard, for the decoded image signal stored in the frame memory 21 (step S210). The inter-frame predictor 232 outputs a predicted signal on the basis of the first mode motion compensation, to the switch 235. The switch 235 outputs the predicted signal on the basis of the first mode motion compensation, to the subtractor 13 (step S211).

The inter-frame predictor 232 determines whether or not the first mode motion compensation is executed for all the frames in the acquired frame group (step S212). When the inter-frame predictor 232 determines that there is a frame for which the first mode motion compensation is not yet executed (step S212: NO), the inter-frame predictor 232 returns the processing to step S210. When the inter-frame predictor 232 determines that the first mode motion compensation has been executed for all of the frames (step S212: YES), the inter-frame predictor 232 terminates the motion compensation processing for the acquired frame group.

The coding apparatus 1 of the embodiment generates coded data having a small coding amount and allowing for generation of a high-quality decoded image, by motion compensation on the basis of projective transformation of an image of a physical body. Thus, the coding apparatus 1 of the embodiment can improve the coding efficiency of the image.

The following appendices are disclosed regarding the coding apparatus 1 of the embodiment.

### APPENDIX 1

A coding method for coding an image to be coded using a reference image includes identifying a reference area being a part of the reference image, the reference area corresponding to an area to be coded being an area obtained by dividing the image to be coded, and obtaining a predicted area with respect to the area to be coded, by prediction using the reference area, wherein
the area to be coded and the reference area have different sizes and/or different shapes, and in the identifying, the reference area is identified by utilizing a difference between a manner of projection of an object corresponding to the area to be coded and a manner of projection of the object corresponding to the reference area, due to an operation performed on a camera when the image to be coded and the reference image are acquired.

### APPENDIX 2

In the coding method described above, the operation performed on the camera is at least one of pan, tilt, roll, or zoom, or a combination of at least two of pan, tilt, roll, or zoom.

### APPENDIX 3

In the coding method described above, in the identifying, the operation is identified by using a camera parameter related to the image to be coded and a camera parameter related to the reference image.

### APPENDIX 4

In the coding method described above, in the identifying, when the operation is at least one of pan, tilt, roll, or zoom, the reference area is identified by using a parameter expressed in one dimension.

### APPENDIX 5

In the coding method described above, in the identifying, a homography matrix is generated by using a one-dimensional component of a motion vector at one specific point of the image to be coded, a camera parameter at a time when the image to be coded is acquired, and a camera parameter at a time when the reference image is acquired, and the generated homography matrix is used for identification.

### APPENDIX 6

In the coding method described above, in the identifying, when the operation is a combination of at least two of pan, tilt, roll, or zoom, the reference area is identified by using a combination of parameters expressed in one dimension or a parameter expressed in two dimensions.

### APPENDIX 7

In the coding method described above, in the identifying, when two-dimensional components of a motion vector at one specific point of the image to be coded are used, a homography matrix is generated by using the two-dimensional components, a camera parameter at a time when the image to be coded is acquired, and a camera parameter at a time when the reference image is acquired, and the generated homography matrix is used for identification, and when one-dimensional components of respective motion vectors at two specific points of the image to be coded are used, a homography matrix is generated by using the one-dimensional components, a camera parameter at a time when the image to be coded is acquired, and a camera parameter at a time when the reference image is acquired, and the generated homography matrix is used for identification.

### APPENDIX 8

In the coding method described above, in the identifying, when the operation is a combination of at least three of pan, tilt, roll, or zoom, the reference area is identified by using a parameter expressed in one dimension and a parameter expressed in two dimensions.

### APPENDIX 9

In the coding method described above, in the identifying, a homography matrix is generated by using two-dimensional components of a motion vector at one of two specific points of the image to be coded, a one-dimensional component of a motion vector at the other one of the two specific points, a camera parameter at a time when the image to be coded is acquired, and a camera parameter at a time when the reference image is acquired, and the generated homography matrix is used for identification.

### APPENDIX 10

In the coding method described above, in the identifying, when the operation is a combination of all of pan, tilt, roll, and zoom, the reference area is identified by using a plurality of parameters expressed in two dimensions.

### APPENDIX 11

In the coding method described above, in the identifying, a homography matrix is generated by using two-dimensional components of motion vectors at two specific points of the image to be coded, a camera parameter at a time when the image to be coded is acquired, and a camera parameter at a time when the reference image is acquired, and the generated homography matrix is used for identification.

Although the embodiment of the present invention has been described in detail with reference to the drawings, a specific configuration is not limited to the embodiment, and a design or the like in a range that does not depart from the gist of the present invention is included.

### INDUSTRIAL APPLICABILITY

The present invention is applicable to a coding apparatus that performs lossless coding or lossy coding of a still image or a moving image.

### REFERENCE SIGNS LIST

1 . . . Coding apparatus
10 . . . Camera parameter determination unit
11 . . . Parameter number determination unit
12 . . . Motion vector determination unit
13 . . . Subtractor
14 . . . Transformer
15 . . . Quantizer
16 . . . Entropy coder
17 . . . Inverse quantizer
18 . . . Inverse transformer
19 . . . Adder
20 . . . Distortion removal filter
21 . . . Frame memory
22 . . . Intra-frame predictor
23 . . . Motion compensator
24 . . . Switch
231 . . . Analyzer
232 . . . Inter-frame predictor
233 . . . Matrix generator
234 . . . Projective transformer
235 . . . Switch

1. A coding method for coding an image to be coded using a reference image, the coding method comprising:
identifying a reference area being a part of the reference image, the reference area corresponding to an area to be coded being an area obtained by dividing the image to be coded; and
obtaining a predicted area with respect to the area to be coded, by prediction using the reference area, wherein
the area to be coded and the reference area have different sizes and/or different shapes, and
in the identifying, the reference area is identified by utilizing a difference between a manner of projection of an object corresponding to the area to be coded and a manner of projection of the object corresponding to the reference area, due to an operation performed on a camera when the image to be coded and the reference image are acquired.

2. The coding method according to claim 1, wherein
the operation performed on the camera is at least one of pan, tilt, roll, or zoom, or a combination of at least two of pan, tilt, roll, or zoom.

3. The coding method according to claim 2, wherein
in the identifying, the operation is identified by using a camera parameter related to the image to be coded and a camera parameter related to the reference image.

4. The coding method according to claim 3, wherein
in the identifying, when the operation is at least one of pan, tilt, roll, or zoom, the reference area is identified by using a parameter expressed in one dimension.

5. The coding method according to claim 4, wherein
in the identifying, a homography matrix is generated by using a one-dimensional component of a motion vector at one specific point of the image to be coded, a camera parameter at a time when the image to be coded is acquired, and a camera parameter at a time when the reference image is acquired, and the generated homography matrix is used for identification.

6. The coding method according to claim 3, wherein
in the identifying, when the operation is a combination of at least two of pan, tilt, roll, or zoom, the reference area is identified by using a combination of parameters expressed in one dimension or a parameter expressed in two dimensions.

7. The coding method according to claim 6, wherein
in the identifying, when two-dimensional components of a motion vector at one specific point of the image to be coded are used, a homography matrix is generated by using the two-dimensional components, a camera parameter at a time when the image to be coded is acquired, and a camera parameter at a time when the reference image is acquired, and the generated homography matrix is used for identification, and when one-dimensional components of respective motion vectors at two specific points of the image to be coded are used, a homography matrix is generated by using the one-dimensional components, a camera parameter at a time when the image to be coded is acquired, and a camera parameter at a time when the reference image is acquired, and the generated homography matrix is used for identification.

8. The coding method according to claim 3, wherein
in the identifying, when the operation is a combination of at least three of pan, tilt, roll, or zoom, the reference area is identified by using a parameter expressed in one dimension and a parameter expressed in two dimensions.

9. The coding method according to claim 8, wherein
in the identifying, a homography matrix is generated by using two-dimensional components of a motion vector at one of two specific points of the image to be coded, a one-dimensional component of a motion vector at the other one of the two specific points, a camera parameter at a time when the image to be coded is acquired, and a camera parameter at a time when the reference image is acquired, and the generated homography matrix is used for identification.

10. The coding method according to claim 3, wherein
in the identifying, when the operation is a combination of all of pan, tilt, roll, and zoom, the reference area is identified by using a plurality of parameters expressed in two dimensions.

11. The coding method according to claim 10, wherein
in the identifying, a homography matrix is generated by using two-dimensional components of motion vectors at two specific points of the image to be coded, a camera parameter at a time when the image to be coded is acquired, and a camera parameter at a time when the reference image is acquired, and the generated homography matrix is used for identification.

12. A coding apparatus for coding an image to be coded using a reference image, the coding apparatus comprising:
an identification unit configured to identify a reference area being a part of the reference image, the reference area corresponding to an area to be coded being an area obtained by dividing the image to be coded; and
a predictor configured to obtain a predicted area with respect to the area to be coded, by prediction using the reference area, wherein
the area to be coded and the reference area have different sizes and/or different shapes, and
the identification unit identifies the reference area by utilizing a difference between a manner of projection of an object corresponding to the area to be coded and a manner of projection of the object corresponding to the reference area, due to an operation performed on a camera when the image to be coded and the reference image are acquired.

13. A non-transitory computer-readable medium having computer-executable instructions that, upon execution of the instructions by a processor of a computer, cause the computer to function as the coding apparatus according to claim 12.
